(19) United States
(12) Patent Application Publication
(10) Pub. No.: US 2004/0170732 A1
(43) Pub. Date: Sep. 2, 2004

(54) Method for improved absorption of additives in molded edible products

(76) Inventors: Glen Axelrod, Colts Neck, NJ (US); Ajay Gajria, Plainsboro, NJ (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/375,470

(22) Filed: Feb. 27, 2003

(51) Int. Cl. A01J 1/00

(52) U.S. Cl. 426/516

(57) ABSTRACT

A method of providing for the absorption of an oil-based and/or aqueous based additive into an edible molding composition including the steps of supplying an edible molding composition, supplying an oil based and/or aqueous based additive and supplying fiber. The edible molding composition is combined with the oil based and/or aqueous based additive and the fiber, wherein the ail based and/or aqueous based additive is selectively absorbed into the fiber, and the fiber may be distributed within the edible molding composition.

### FIELD OF THE INVENTION

The invention relates to a method of manufacturing edible molded products, and more particularly relates to a method of manufacturing molded edible products having improved uptake of oil-based or aqueous based additives, and which molded edible product also provides improved resistance to loss of moisture. The manufacturing method disclosed herein employs melt mixing of starch, protein, or gluten, fiber, flavoring and other additives, followed by injection molding into a selected shape.

### BACKGROUND OF THE INVENTION

Most dogs enjoy chewing on things although preferences vary as to the hardness of the substances favored. Some dogs like to chew on very hard materials such as cow bones, wood, nylon or polyurethane, others prefer softer chews such as rawhide, while still others favor freeze dried snacks. Some dogs, due to their age, may not be able to chew on the hard substances. Young dogs have insufficiently developed teeth, while old dogs may have diseased gums or may have lost some of their teeth.

Many completely indigestible objects are given to dogs as a chew and although the dogs may enjoy chewing on them, the objects may be swallowed in whole or in part. Once swallowed, these objects or fragments thereof can have an adverse effect on the dog's digestion and can become impacted in the dog's intestinal tract with life-threatening consequences.

In appreciation of this problem, there has been previously developed an edible dog chew that is digestible and nutritious along with a texture or hardness which is individually adjustable by the application of heat to suit a wide variety of dog's preferences or needs. Such dog chews utilize a mixture containing primarily casein and are disclosed in U.S. Pat. Nos. 5,200,212 and 5,240,720, which are assigned to T.F.H. Publications, Inc. Other wholly digestible, edible dog chews have also been developed that are formed largely from various starch products.

In U.S. Pat. No. 5,827,565 owned by the common assignee of this application, there is disclosed a process for making a heat expandable dog chew comprised primarily of injection molding potato starch granules and an attractant. Attractants recited include chicken powder, liver powder, ham, turkey, beef and or fish. Natural vegetable additives such as spinach or carrots also may be added. The resultant mixture is molded under heat and pressure into a desired form, such as a dog bone. The dog bone so produced can be modified in texture or hardness by subsequent heating, preferably in a microwave oven.

In U.S. Pat. No. 6,126,978, which is a continuation-in-part of U.S. Pat. No. 5,827,565, and which is owned by the common assignee of this Application, there is disclosed a dog chew having natural fruit flavor to increase the dog's appetite for such chew. Such fruit flavored dog chew may also include natural food coloring to enhance the attractiveness of the chew to the dog owner. The food coloring may also correspond to the fruit flavor, and the dog chew disclosed therein may also embody a breath sweetener for a dog such as mint, spearmint, peppermint or wintergreen and may also include parsley. The preferred form of such edible chew maintained the basic ingredient of a heat-expandable starch, such as potato starch. Fruit flavoring may be added to the granules of a mixture of potato starch, water and calcium carbonate along with natural fruit flavorings.

Attention is also directed to the following U.S. Patents, commonly owned by the assignee herein: U.S. Pat. No. 5,476,069 entitled “Molded Rawhide Chew Toy”; U.S. patent application Ser. No. 08/923,070 filed Sep. 3, 1997 entitled “Vegetable Based Dog Chew” now U.S. Pat. No. 6,093,427; U.S. patent application Ser. No. 08/738,423 filed Oct. 25, 1997 entitled “Edible Dog Chew” now U.S. Pat. No. 5,827,565; U.S. patent application Ser. No. 08/784,834 filed Jan. 17, 1997 entitled “Carrot-Based Dog Chew” now U.S. Pat. No. 5,941,197; U.S. patent application Ser. No. 09/114,872 filed Jul. 14, 1998 entitled “Heat Modifiable Edible Dog Chew” now U.S. Pat. No. 6,180,161; U.S. patent application Ser. No. 09/138,804 filed Aug. 21, 1998 entitled “Improved Edible Dog Chew” now U.S. Pat No. 6,126,978; U.S. patent application Ser. No. 09/116,070filed Jul. 15, 1998 entitled “Wheat & Casein Dow Chew. With Modifiable Texture” now U.S. Pat. No. 6,110,521; U.S. patent application Ser. No. 09/116,555 filed Jul. 15, 1998entitled “Heat Modifiable Peanut Dog Chew” now U.S. Pat. No. 6,093,441; U.S. patent application Ser. No. 09/227,767 filed Jan. 8, 1999 entitled “Method of Molding Edible Starch” now U.S. Pat. No. 6,159,516. In addition to such patents, attention is also directed to the art cited in said patents and applications, as such art may relate to the field of molded edible products of a starch or protein composition.

Additionally, while the above prior art confirms the variety successful efforts to provide an edible chew, there is nonetheless a need to continue to improve upon such technology and provide a chew toy that will absorb additive flavoring more efficiently, while also providing an improved shelf life for the chew toy product.

Accordingly, it is an object of the present invention to provide an animal chew capable of enhanced uptake of oil-based or aqueous based flavorings/attractants, and with an overall improved resistance to the loss of moisture and an improved shelf life. More specifically, it is an object of the present invention to particularly improve the flavoring characteristics of starch and protein based upon the use of oil based and/or aqueous based flavoring additives, through the fiber.

### SUMMARY OF THE INVENTION

The present invention is directed at a method of providing for the absorption of an oil-based and/or aqueous based additives into an edible molded composition including the steps of supplying and combining an edible molding composition, an oil based and/or aqueous based additive, and fiber. The oil-based and/or aqueous based additive is selectively absorbed into the fiber, and the fiber is distributed within the edible molding composition.

In a first particular embodiment, the present invention is directed at a method of providing for the absorption of an oil-based and/or aqueous based additive into a wheat starch based composition including the steps of supplying wheat starch, supplying an oil based and/or aqueous based additive and supplying oat fiber. The oil based and/or aqueous based additive is selectively absorbed into said oat fiber, and said oat fiber may be distributed within said wheat starch.

In a second embodiment, the present invention is directed at a method of providing for the absorption of an oil-based and/or aqueous based additive into a wheat starch based composition including the steps of supplying wheat starch, supplying an oil based and/or aqueous based additive and supplying oat fiber. The oat fiber is combined with said oil based and/or aqueous based additive wherein said oil based and/or aqueous based additive is absorbed into said oat fiber. The oat fiber containing said oil based and/or aqueous based additive is combined with said wheat starch wherein said oat fiber is distributed within said wheat starch.

In a third embodiment, the present invention is directed at a method for forming an animal chew having increased uptake of oil based and/or aqueous based flavoring additives, the method comprising combining wheat starch, oat fiber, an oil based and/or aqueous based flavoring additive and water to form a mixture wherein the water content is in the range of about 20.0 to 40.0 wt % and said oil based and/or aqueous based flavoring additive is selectively absorbed into said oat fiber. The mixture is introduced and heated in a vented barrel extruder to form extruded beads wherein the water content of said beads upon discharge from said extruder is less than the water content of said mixture entering said extruder, and wherein said oat fiber containing said oil based and/or aqueous based flavoring additive is distributed within said wheat starch. This may be followed by introducing the extruded beads to a heated injection molding machine and injection molding and cooling to form a molded article wherein the water content of said molded article is at or below about 20 wt %, and wherein the injection molding machine contains a hopper feed section, a barrel and an output nozzle, including a plurality of heating zones in said barrel extending from said hopper section to said nozzle, wherein said heating zone in said barrel adjacent said hopper is maintained at a temperature of less than about 150 degrees F.

### DESCRIPTION OF THE PREFERRED EMBODIMENTS OF THE INVENTION

In accordance with the present invention, a method of manufacturing edible molded products having improved oil-based and aqueous based additive uptake and retention is disclosed. The method of the present invention may preferably include an initial extrusion melt mixing of an edible molding composition, such as a starch, protein or gluten based composition, with water, vegetable/plant based fiber and selected amounts of said oil based and/or aqueous based additives, followed by injection molding into a selected shape. Preferably the products herein are manufactured in the form of chew toys and other similar shaped products for pets.

Using vegetable/plant based fiber to improve the uptake of oil-based and aqueous based additives, consistent with the present invention, is applicable to edible molded products including edible molding compositions that are based on moldable starch, moldable proteins, and moldable glutens. As alluded to previously, most plant or vegetable based fibers may be suitably employed to improve the uptake of additive. For example, the suitable fiber products include cellulose, corn fiber, wheat bran, oat fiber, etc. As also suggested, oil-based and aqueous additive uptake is uniquely improved for starch based edible molded products, protein based edible molded products, and gluten based edible molded products, which products typically exhibit poor additive absorption and retention. Exemplary starch based products may be based on potato starch, corn starch, wheat starch, etc. Exemplary protein based products may be based on casein, animal protein (such as animal meal), vegetable protein, protein colloid(s), etc.

According to one exemplary embodiment, the molded product may be a starch based material in which the uptake of oil-based and aqueous additives is improved through the addition of fiber. In the specific embodiment, the starch based material may be a wheat starch based material. Additionally, the fiber product employed to improve the uptake of oil-based and aqueous additive may be an oat fiber based product. Particularly, it has been found that Snowite® oat fiber available from Canadian Harvest is especially suitable in the context of the following exemplary embodiment.

Consistent with the exemplary embodiment referred to above, wheat starch may be moisture preconditioned to set the water content of the starch in the range of about 20-40 wt. % with respect to the starch. Adjusting the moisture content may be achieved, for example, by mixing the starch with water in a moisture preconditioner that provides controlled premoisturization and complete mixing of the water with the starch material. This may then be followed by introducing the starch/water combination and the other ingredients, i.e., oat fiber, oil based and/or aqueous based additives, and optionally fillers, into a compounding extruder. Desirably, the extruder may be a twin screw extruder, although single screw extrusion may provide acceptable results.

The ingredients, including the starch, water, oat fiber, and oil based and/or aqueous based additives are heated and mixed in the extruder. In the context of the present invention, the moisture content of the mixture is preferably lowered during melt extrusion. The extruder may be provided with a vented barrel to facilitate the venting of moisture as the mixture is melt processed and moisture is driven off. To further aid the water level change, it may be useful to apply a light vacuum to the extruder barrel at a vent port therein to provide more efficient removal of water from the extrudate.

As noted, the moisture content of the mixture as introduced in to the extruder is in the range of about 20-40 wt %. This level is preferably lowered during extrusion. The extrudate having a thus adjusted moisture content may conveniently be formed in the shape of beads or pellets using standard palletizing equipment.

Once the extruded beads are produced, the starch/oat fiber/water may optionally be placed in a dryer to further adjust the water content to a level lower than the as extruded moisture level. Preferably, the water level of the starch/oat fiber/water extrudate is lowered within the range of about 10-20 wt. %, at which point the extrudate is in condition for injection molding.

In the step of injection molding, preferably the injection molding techniques is similarly configured to further reduce the moisture content to a final level that is at or below about 20 wt. %. However, in preferred embodiment, the final level of water in the molded product is between about 5-20 wt. %, in a more preferably embodiment the water level of the molded product is set to about 10-18 wt. %, and in a most preferred embodiment the water level of the molded product is set to about 12-17 wt. % or 12-16 wt. %. It has been found, therefore, that by sequencing the loss of water, from extrusion, to injection molding, one may achieve outstanding quality of the various shaped products in accordance with the present invention.

Those skilled in the art will also appreciate that an injection molding machine generally contains a hopper feed section, a barrel and an output nozzle, including a plurality of heating zones in the barrel extending from the hopper section to the nozzle. Consistent with the exemplary embodiment of the present invention, it has been found advantageous to maintain the temperature in the first zone adjacent the hopper at a temperature of less than about 150 degrees F. More preferably, the first zone adjacent the hopper is set in the range of about 45-150 degrees F. In a more preferred embodiment, i.e., that situation wherein there is a first zone adjacent the hopper, and a second zone adjacent the first zone, the temperature of the first zone is set to about 45-100 degrees F., and the second zone is set to about 70-150 degrees F. These temperatures are preferably achieved by the use of cooling coils placed around the barrel of the injection molding machine. The cooling coils may be, for example, copper cooling coils circulating water.

With regard to achieving optimum results from the injection molding process, it has therefore been found useful, as noted above, to actually the cool the initial zone or zones of the injection molding machine proximate to the hopper and feed section, according to the preferred temperature profiles above. This is contrary to typical injection molding practices, wherein generally uniform heating, above the resin's melting temperature, is applied to all zones of the injection molding apparatus.

According to the exemplary and preferred embodiment detailed herein, the following temperature profile has been successfully employed in conjunction with a standard injection molding machine: Zone 1 (closest to the hopper)=45-100 degrees F., Zone 2=70-150 degrees F., Zone 3=150-300 degrees F., Zone 4=200-375 degrees F., Nozzle=275-425 degrees F. In addition, it is desirable that the bushing inside the mold preferably be maintained at a temperature in the range of about 250-425 degrees F. The mold itself may be desirably maintained at a temperature in the range of about 35-65 degrees F.

In contrast to conventional injection molding practice of heating the barrel of the screw to a melt the material in the zones proximate the hopper, according to the present invention the barrel is therefore actually cooled at such regions to prevent the starch material from over-heating and burning. Those skilled in the art will recognize that in the case of preparing a high-quality injection molded starch product, burning has been a pervasive problem. Accordingly, the present invention uniquely appreciates that such over-heating and burning can be regulated by actually cooling the barrel of the of the injection molding machine, thereby minimizing the ability of the starch to thermally degrade.

Significant in the present invention, various additives and processing aids may be advantageously combined in the edible product, either before/during extrusion or before/during injection molding, to further improve the quality, desirability, or strength characteristics of the molded products ultimately produced. For example, and for the purpose of preparing a pet chew toy, it has been found preferably to add flavorings in an amount of from about 1.0-5.0 wt. %, and at all 0.1 wt. % increments therebetween Such flavoring may often be extracts from meat products such as chicken, liver, ham, turkey, beef and/or fish. Such flavorings may be provided as a powder, an aqueous liquid, or an oil-based liquid.

Numerous other oil-based and/or aqueous based additives may also be desirable ingredients in pet chew toys. In addition to flavorings, desired additives may include olfactory attractants, vitamins, as well as various nutritional supplements. Such additive may not only further entice an animal to chew on the molded product, but when consumed may also provide desirable health benefits.

The use of oil-based liquid additives and/or aqueous based additives, in general, has previously been limited because moldable starch, protein and gluten products generally have a very poor affinity for oil-based liquid additives and/or aqueous based additives. Therefore, the molded starch, protein or gluten will not efficiently absorb and retain sufficient quantities of such additives. However, in the present invention, it has been uniquely recognized that either the oil based additives or aqueous based additives may be selectively absorbed into vegetable or plant based fibers, such as the oat fiber of the exemplary embodiment, corn fiber, wheat bran, cellulose. The fiber may then be distributed within the starch, protein or gluten, such that the starch, protein or gluten is effectively flavored and such flavoring remains within the edible molding composition in amounts sufficient to attract an animal's interest, provide the desired health benefits, etc.

By providing fiber in combination with the starch, protein or gluten both aqueous and oil-base additives may now be more effectively utilized and uniformly distributed in the molded edible starch or protein product. Optimum additive uptake may be achieved by employing fiber in an amount of from about 1.0-10.0 wt. %, and at all 0.1 wt. % increments therebewteen. The addition of such fiber has been shown to actually improve the retention of the added flavoring, attractant, vitamin, etc. for longer periods of times than by direct addition of the oil based or aqueous based additives to the starch, protein or gluten alone.

Additionally, it has been the case that once a molded starch, protein or gluten product was prepared, over time water may migrate out of the molded product, thereby making the starch or protein very brittle, which, of course, would be unsuitable in the case of a pet chew toy. However, it has been found that in the present invention, the fiber can be relied upon to perform two tasks. First, as noted, the fiber serves as an efficient carrier of either the oil based or aqueous based additive. Second, the fiber also simultaneously serves as a humectant thereby maintaining the moisture in the molded product such that the starch, protein or gluten will not desiccate as rapidly and become unacceptable for a chew toy application.

The various pet chew toys made in accordance with the present invention have been found, for example, to be popular with dogs, by virtue of its chewability and consistency, improved mechanical properties, and attractant or flavoring loading. As the dog chews on the product the animal is provided with the nutritional benefit of the components contained therein. In such regard, and in consideration of the suitability of the molded products herein as dog chews, additives such as vitamins and nutritional supplements may be added to the product, either during extrusion or injection molding, and the fiber again serves to efficiently carry either an oil based and/or aqueous based vitamin within the starch, protein or gluten continuous phase.

The present invention has been set forth in reference to various exemplary preferred embodiments, but it should be understood by those skilled in the art that such exemplary embodiments are by way of illustration only. Modifications and variation will therefore be apparent and may be sorted to without departing from the spirit and equivalent scope of this invention. Accordingly, such modifications and equivalents should be considered to be within the purview of the scope of the invention as set forth in the appended claims.

What is claimed is:

1. A method of providing for the absorption of an oil-based and/or aqueous based additive into an edible molded composition comprising:
(a) supplying an edible molding composition;
(b) supplying an oil based and/or aqueous based additive;
(c) supplying fiber;
(d) combining said edible molding composition, said oil based and/or aqueous based additive and said fiber, wherein said oil based and/or aqueous based additive is selectively absorbed into said fiber, and said fiber is distributed within said edible molding composition.

2. The method of claim 1 wherein said edible molding composition comprises a starch based molding composition.

3. The method of claim 1 wherein said edible molding composition comprises a protein based molding composition.

4. The method of claim 1 wherein said edible molding composition comprises a gluten based molding composition.

5. The method of claim 1 wherein said fiber comprises a plant/vegetable fiber.

6. The method of claim 1 wherein said fiber is present at a level of about 0.1-10.0 wt. %.

7. The method of claim 1 wherein said oil based and/or aqueous based additive comprises one of a flavoring or an olfactory attractant, a vitamin, a nutritional supplement, or a mixture thereof.

8. The method of claim 1 wherein said oil based and/or aqueous base additive is present at a level of about 0.1-5.0 wt. %.

9. The method of claim 1 wherein said step (d) is conducted in a melt mixing apparatus.

10. The method of claim 9 wherein said melt mixing apparatus comprises an extruder or an injection molding machine.

11. A method of providing for the absorption of an oil-based and/or aqueous based additive into a wheat starch based composition comprising:
(a) supplying wheat starch;
(b) supplying an oil based and/or aqueous based additive;
(c) supplying oat fiber;
(d) combining said wheat starch, said oil based and/or aqueous based additive and said oat fiber, wherein said oil based and/or aqueous based additive is selectively absorbed into said oat fiber, and said oat fiber is distributed within said wheat starch.

12. The method of claim 11 wherein said oat fiber is present at a level of about 0.1-10.0 wt. %.

13. The method of claim 11 wherein said oil based and/or aqueous based additive comprises one of a flavoring or an olfactory attractant, a vitamin, a nutritional supplement, or mixture thereof.

14. The method of claim 11 wherein said oil based and/or aqueous based additive is present at a level of about 0.1-5.0 wt %.

15. The method of claim 11 wherein said step (d) is conducted in a melt mixing apparatus.

16. The method of claim 15 wherein said melt mixing apparatus comprises an extruder or an injection molding machine.

17. The method of claim 15 wherein said melt mixing apparatus comprises an injection molding machine which contains a hopper feed section, a barrel and an output nozzle, including a plurality of heating zones extending from said hopper section to said nozzle, wherein said heating zone in said barrel adjacent said hopper is maintained at a temperature of less than about 150 degrees F.

18. The method of claim 15 wherein said melt mixing machine comprises an injection molding machine which contains a hopper feed section, a barrel and an output nozzle, including four heating zones extending from said hopper section to said nozzle, wherein said heating zones are set within the following temperature ranges, extending from said hopper to said nozzle:
zone 1=at or below 100 degrees F.
zone 2=at or below 150 degrees F.
zone 3=at or below 300 degrees F.
zone 4=at or below 375 degrees F.

19. A method of providing for the absorption of an oil-based and/or aqueous based additive into a wheat starch based composition comprising:
(a) supplying wheat starch;
(b) supplying an oil based and/or aqueous based additive;
(c) supplying oat fiber;
(d) combining said oat fiber with said oil based and/or aqueous based additive wherein said oil based and/or aqueous based additive is absorbed into said oat fiber;
(e) combining said oat fiber containing said oil based and/or aqueous based additive with said wheat starch wherein said oat fiber is distributed within said wheat starch.

20. The method of claim 19 wherein said oat fiber is present at a level of about 0.1-10.0 wt. %.

21. The method of claim 19 wherein said oil based and/or aqueous based additive comprises one of a flavoring, an olfactory attractant, a vitamin, a nutritional supplement, or mixture thereof.

22. The method of claim 19 wherein said oil based and/or aqueous based additive is present at a level of about 0.1-5.0 wt %.

23. The method of claim 19 wherein said step (d) is conducted in a melt mixing apparatus.

24. The method of claim 23 wherein said melt mixing apparatus comprises an extruder or an injection molding machine.

25. The method of claim 23 wherein said melt mixing apparatus comprises an injection molding machine which contains a hopper feed section, a barrel and an output nozzle, including a plurality of heating zones extending from said hopper section to said nozzle, wherein said heating zone in said barrel adjacent said hopper is maintained at a temperature of less than about 150 degrees F.

26. The method of claim 23 wherein melt mixing apparatus comprises an injection molding machine wherein said injection molding machine contains a hopper feed section, a barrel and an output nozzle, including four heating zones extending from said hopper section to said nozzle, wherein said heating zones are set within the following temperature ranges, extending from said hopper to said nozzle:
zone 1=at or below 70 degrees F.
zone 2=at or below 150 degrees F.
zone 3=at or below 300 degrees F.
zone 4=at or below 375 degrees F.

27. A method for forming an animal chew having increased uptake of oil based and/or aqueous based flavoring additives, the method comprising;
(a) combining wheat starch, oat fiber, an oil based and/or aqueous based flavoring additive and water to form a mixture wherein the water content is in the range of about 20.0 to 40.0 wt % and said oil based and/or aqueous based flavoring additive is selectively absorbed into said oat fiber;
(b) introducing and heating said mixture in a vented barrel extruder to form extruded beads wherein the water content of said beads upon discharge from said extruder is less than the water content of said mixture entering said extruder, and wherein said oat fiber containing said oil based and/or aqueous based flavoring additive is distributed within said wheat starch;
(c) introducing the extruded beads of (b) to a heated injection molding machine and injection molding and cooling to form said molded article wherein the water content of said molded article is at or below about 20 wt %, wherein the injection molding machine contains a hopper feed section, a barrel and an output nozzle, including a plurality of heating zones in said barrel extending from said hopper section to said nozzle, wherein said heating zone in said barrel adjacent said hopper is maintained at a temperature of less than about 150 degrees F.;

28. The method according to claim 27 wherein said oat fiber is combined at a content of about 1.0-10.0 wt. %.

29. The method according to claim 27 wherein said oil based and/or aqueous based additive is combined at a content of about 0.1-5.0 wt %.

30. The method according to claim 27 further comprising the step of introducing the product of step (b) to a dryer and reducing the water content to a level less than that of the water content of said product discharged from said extruder.

31. The method according to claim 27 wherein said plurality of heating zones comprises four heating zones, extending from said hopper to said nozzle, which are provided with the following temperature ranges:
zone 1=at or below 70 degrees F.;
zone 2=at or below 150 degrees F.;
zone 3=at or below 300 degrees F.;
zone 4=at or below 375 degrees F.
